(19) United States
(12) Patent Application Publication
(10) Pub. No.: US 2017/0252749 A1
(43) Pub. Date: Sep. 7, 2017

(54) PROCESSING BLADE

(71) Applicants: Daniel T. Miller, Boardman, OH (US); Dean E. Grindley, III, Sebring, OH (US)

(72) Inventors: Daniel T. Miller, Boardman, OH (US); Dean E. Grindley, III, Sebring, OH (US)

(21) Appl. No.: 15/059,583

(22) Filed: Mar. 3, 2016

(51) Int. Cl. B02C 18/18; B02C 18/04

(52) U.S. Cl. CPC B02C 18/18; B02C 18/04; B02C 2210/02

(57) ABSTRACT

A compound blade assembly for recycling machines that process random sized waste metals into uniform reusable material. A rotating processing blade and a fixed registerable bed blade each have interchangeable blade teeth sets of multiple blade edge surfaces for interengaging target waste material at multiple shear points by registerable intermeshing in a linear progressive repetitive process.

### BACKGROUND OF THE INVENTION

1. Technical Field

This invention relates to machines that will reduce waste material into smaller pieces for reuse, specifically knife blades that use multiple replaceable teeth for engagement with bed blade assemblies.

2. Description of Prior Art

Prior art devices of this type have a movable blade and fixed blade engagement surfaces wherein blades rotate engaging material and cut it into smaller pieces, an example of same can be seen in U.S. Pat. Nos. 3,982,704, 4,797,977, 6,375,106 and 8,616,481.

U.S. Pat. No. 3,982,704 is directed to a grinding disk for disk mills that have multiple annular rings with a plurality of saw teeth removably secured thereto.

U.S. Pat. No. 4,797,977 claims a picker assembly having multiple hook teeth secured on a moving mounting bar.

U.S. Pat. No. 6,375,106 illustrates a waste reduction machine with replaceable teeth mounted radially on a hub.

U.S. Pat. No. 8,616,481 discloses a drum associated with a tooth kit having multiple upstanding teeth positioned on a mounting bar and is removable from the drum for replacement.

### SUMMARY OF THE INVENTION

A blade assembly set for material shredding and grinding having a movable engagement blade with interchangeable teeth and a fixed bed blade for registration therewith. The bed blade progressively intermeshes with each of the multiple blade edges providing for multiple engagement points for enhanced shredding and progressive reduction of waste pieces defined material into smaller processing size in a single stage processing step for reuse, specifically in the recycling industry.

### DESCRIPTION OF THE DRAWINGS

FIG. 1 is a side elevational view of the movable shredding blade of the invention.

FIG. 2 is an enlarged end elevational view thereof.

FIG. 3 is an enlarged side elevational view of a replaceable knife insert therefore.

FIG. 4 is a side elevational view of the fixed bed blade assembly of the invention in use orientation.

FIG. 5 is an end elevational view thereof.

FIG. 6 is an enlarged side elevational view of a knife insert thereon.

FIG. 7 is an enlarged end composite view of the movable and fixed blade orientation interface there between.

FIG. 8 is an enlarged side graphic representation of the blade's progressive interface.

### DETAILED DESCRIPTION OF THE INVENTION

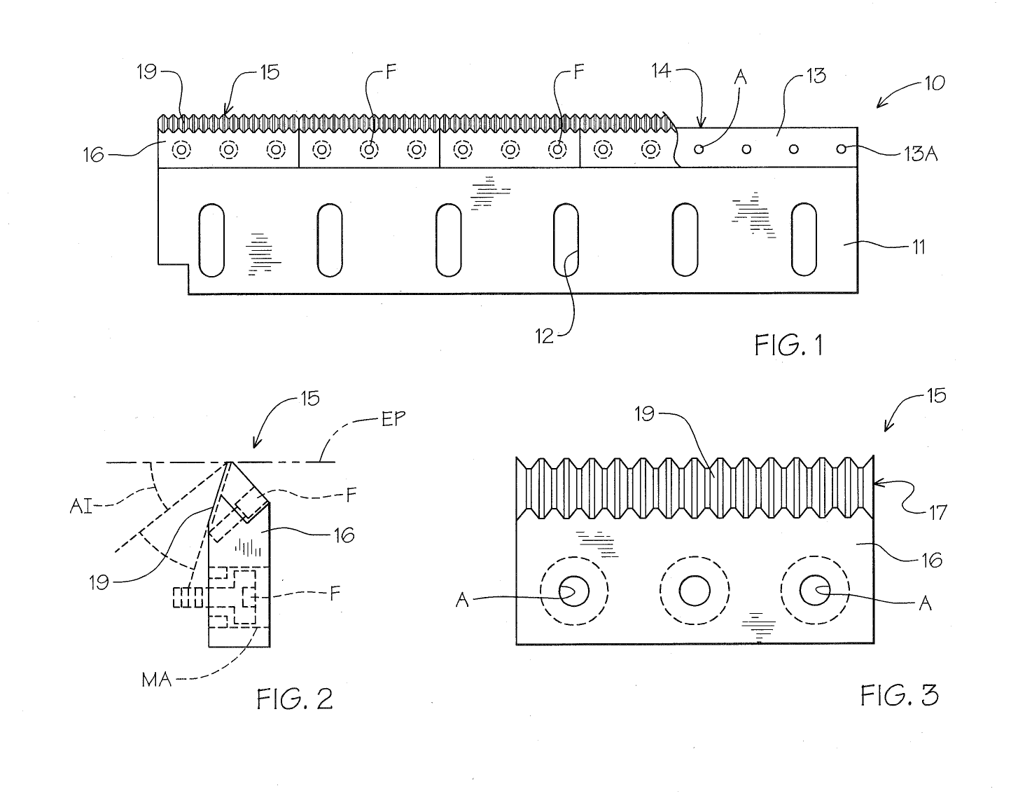

Referring to FIGS. 1, 2 and 3 of the drawings, a primary blade 10 of the invention can be seen having elongated mounting bar body 11 with multiple longitudinally spaced attachment slots 12 therein. The mounting bar body 11 has an elongated offset blade attachment portion 13 extending inwardly from its perimeter edge 14 with a number of blade inserts mounting apertures BA.

Knife edge teeth inserts 15 can be seen in FIGS. 2 and 3 of the drawings having a rectangular body member 16 with correspondingly spaced aligned mounting apertures MA therein for registerable alignment with the hereinbefore disclosed bar body member apertures BA by threaded fasteners F as will be well understood by those skilled in the art and best seen, as broken away, in FIG. 1 of the drawings.

The knife edge insert assemblies 15 are each characterized by a tapered recessed mounting surface 17 for receiving a multiple apertured knife edge fixtures 18 secured thereto by secondary fasteners F through correspondingly aligned apertures. The knife edge fixtures 18 have parallel saw tooth knife edge configurations 19, as best seen in FIG. 2 of the drawings.

It will be evident that the angular inclination of the defined saw tooth knife edge teeth is supported by the angular positioning of a tapered recess mounting surface 17 in the offset blade attachment portion 13. The angular inclination of the teeth edges are approximately forty-five degrees at AI from the horizontal edge blade plane EP graphically illustrated in FIG. 3 of the drawings.

The knife edge inserts 15 are, as noted, secured to the body member 16 in aligned end to end relation providing a continuous multiple shearing and cutting knife edge surfaces along the mounting bar body 11.

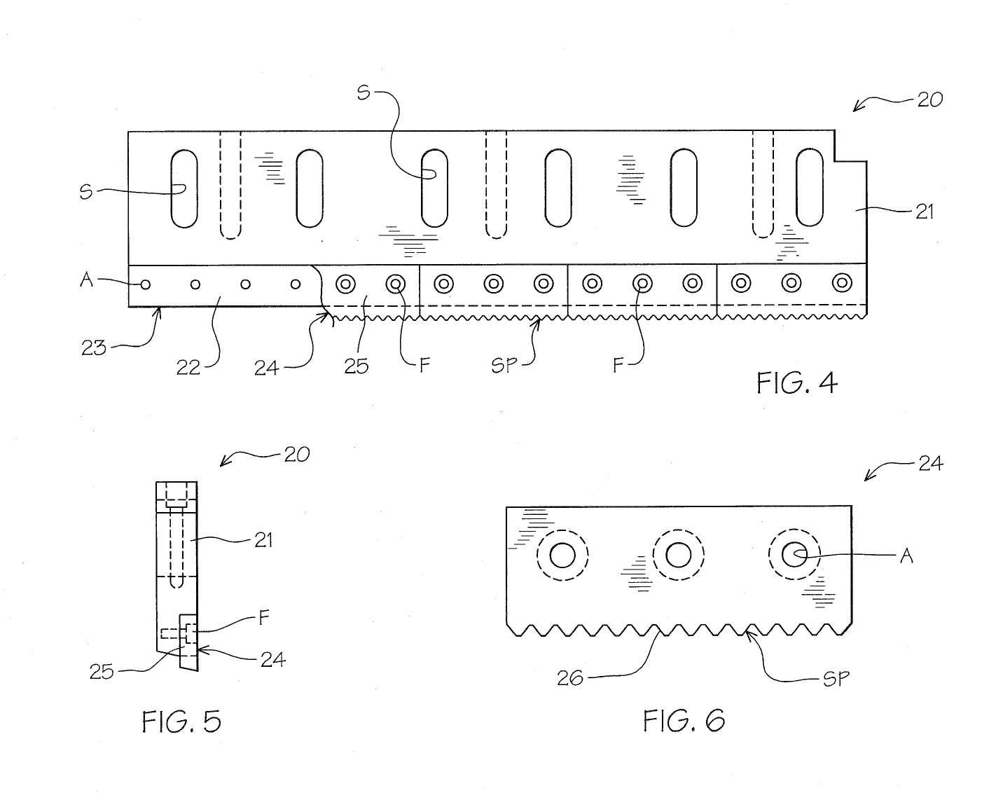

Referring now to FIGS. 4-6 of the drawings, a bed blade 20 can be seen for progressive engagement with the primary blade 10 as will be described in greater detail hereinafter. The bed blade 20 has a plurality of elongated mounting slots S in longitudinally spaced alignment there along.

The blade bed 20 has an elongated body member 21 with an apertured offset blade edge mounting area 22 extending inwardly of its lower perimeter edge 23 when in use orientation.

A plurality of adapted cutting blade inserts 24, best seen in FIG. 5 of the drawings, are selectively secured into the blade edge mounting area 22 in linear end to end alignment to form a continuous cutting knife blade edge there along.

Each of the blade inserts 24 are formed of a rectangular flat body member 25 with spaced mounting apertures A for fasteners F registerable therethrough securing each of the blade inserts 24 to the body member 21 by corresponding aligned apertures A therein.

It will be apparent that this orientation will allow for rapid replacement due to wear or damage as needed.

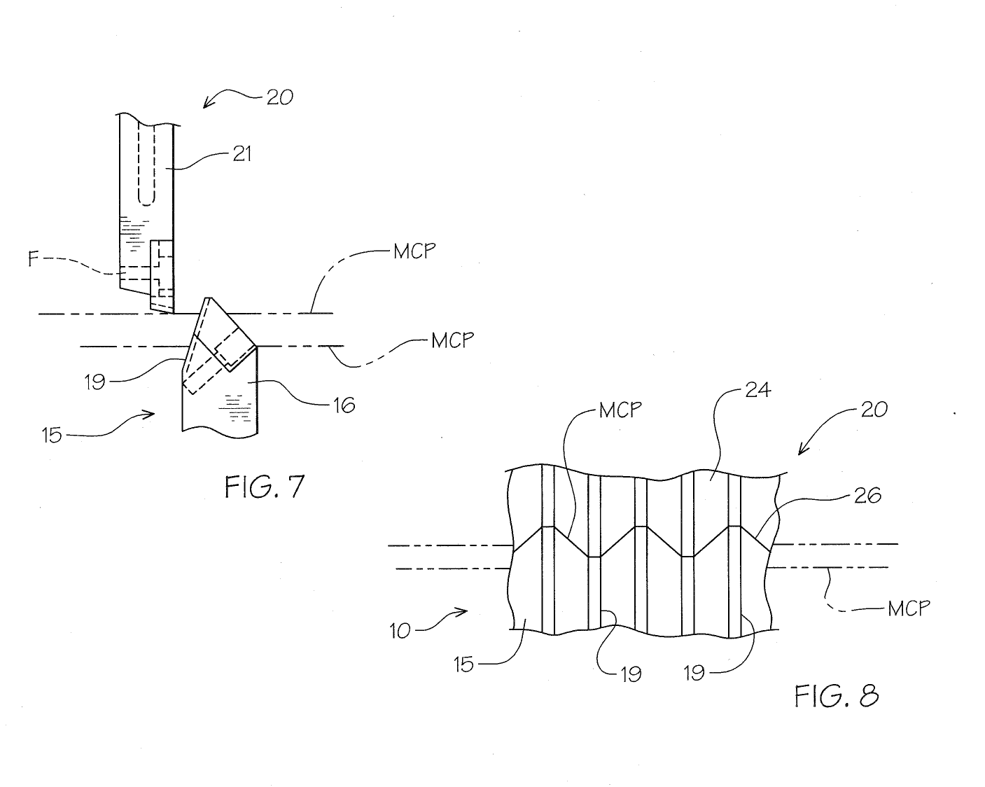

Each of the blade inserts 24 have a plurality of registering knife edge teeth 26 milled therein forming a saw tooth cutting edge pattern SP there along which is of a same size and angular delineation so as to conform with the hereinbefore described angular disposed blade edge assembly saw tooth knife edge inserts 15 as it will be progressively engaged at multiple material contact points MCP there along seen graphically in FIGS. 7 and 8 of the drawings.

It will be seen that by intermeshing the respective angular cutting surfaces of the knife edge insert assemblies 15 during use that the so aligned cutting edges 26 of the bed blade 20 as described define a unique progressive multiple material engagement cutting action which by its multiple points of material contact effectively combine the hereinbefore traditional two-stage two blade cutting sequence required in recycling venues of shredding and grinding to a single compound cutting event of material processing, unique and novel within the art.

As seen in FIGS. 7 and 8 of the drawings the progressive interface between the bed blade 20 and primary blade 10 can be seen wherein the respective saw tooth cutting edges configurations mesh creating a multiple shearing edge cutting points there along to achieve a unique improved and efficient material processing.

It will thus be seen that a new and novel compound shearing blade 10 and bed blade 20 has been illustrated and described and it will be apparent to those skilled in the art that various changes and modifications may be made thereto without departing from the spirit of the invention. Therefore I claim:

1. A compound blade assembly for material processing, said compound blade assembly comprising,
a shredding blade and a registering bed blade,
said shredding blade comprising, a rectangular blade body, multiple knife blade inserts selectively secured along said blade body in end to end relation,
a plurality of knife edge surfaces on said blade insert portions in spaced parallel orientation with one another,
said knife edge surfaces having a saw tooth configuration defining multiple material cutting engagement surfaces there along.

2. The compound blade assembly for material processing set forth in claim 1 wherein said bed blade comprises, a rectangular blade body, an apertured elongated offset blade receiving portion,
longitudinally spaced aligned mounting apertures in said body and said offset blade receiving portion, multiple knife edge fixtures secured on said blade insert portions having multiple fasteners registerable there through.

3. The compound blade assembly for material processing set forth in claim 2 wherein said knife edge fixtures have saw tooth configurations defining multiple cutting engagement surfaces.

4. The compound blade assembly for material processing set forth in claim 1 wherein said knife edge surfaces on said blade insert portions comprises, multiple apertured knife edge fixtures secured thereto by fasteners.

5. The compound blade assembly for material processing set forth in claimed 1 and claim 3 wherein said saw tooth knife edge surfaces of said shredding blade and said knife edge fixtures saw tooth configuration are selectively aligned for progressive intermeshed interface with one another for multiple cutting engagement surfaces.
